(19) United States
(12) Patent Application Publication
(10) Pub. No.: US 2010/0268794 A1
(43) Pub. Date: Oct. 21, 2010

(54) NETWORK TRANSMISSION SYSTEM AND METHOD

(75) Inventor: Kuo Chung Chiu, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTek Computer Inc., Taipei (TW)

(21) Appl. No.: 12/760,127

(22) Filed: Apr. 14, 2010

(30) Foreign Application Priority Data
Apr. 15, 2009 (TW) 098112459

(51) Int. Cl. G06F 15/16

(52) U.S. Cl. 709/219

(57) ABSTRACT

A network transmission system and a method thereof are disclosed in the invention. The network transmission system in the invention includes a server and a terminal connected with each other via the Internet. In addition, the server stores a plurality of existent files each of which corresponds to an existent signature file. When the terminal wants to transmit a target file to the server, the terminal generates a target signature file corresponding to the target file first and transmits the target signature file to the server. The server compares the existent signature files and the target signature file to determiner whether one of the existent signature files is in accordance with the target signature file. If yes, the terminal cannot transmit the target file to the server.

### CROSS-REFERENCE TO RELATED PATENT APPLICATION

This application claims priority to and the benefit of Taiwan Patent Applications No. 098112459, filed Apr. 15, 2009, the contents of which are incorporated herein in their entireties by reference.

### BACKGROUND OF THE INVENTION

1. Field of the Invention

The invention relates to a network transmission system and method and, more particularly, to a network transmission system and method for transmitting files effectively.

2. Description of the Related Art

With the development of the Internet technology, more and more resources are shared or inquired via the Internet. In addition, the Internet providers or the hardware manufacturers actively develop high efficient connecting lines or the accessing modes to allow users to access the Internet more efficiently. For example, the most widely used accessing line includes the asymmetric digital subscriber line (ADSL), an optical fiber, wired TV cable provided for the user to select.

Take the ADSL as an example, the conventional telephone line is used to provide a high Internet access speed in a high frequency digital compression mode. In addition, the ADSL uses the existing telephone line and special modem to increase the digital data download speed to about 1.5 Mbps to 9 Mbps and the digital data upload speed to about 64 Kbps to 640 Kbps. Since no additional line layout is needed, and only the special modem needs to be installed, the ADSL becomes an access line used most widely.

However, limited by the modem mechanism, the transmission way and the transmission distance, the upload speed of the ADSL is much slower than the download speed. Thus, most users use the ADSL to download data, and they are unwilling to spend much time in uploading data, which limits the depth and magnitude of the network resources. In addition, due to the different user habits or file resources, many files with different file names in the network space have the same content, which disturbs the user browsing or searching the Internet and wastes the network resources.

### BRIEF SUMMARY OF THE INVENTION

The invention provides a network transmission system which may effectively transmit files and save network resources to solve the problems in the conventional technology.

According to an embodiment, the network transmission system of the invention includes a server and a first terminal which utilizes a first route to be connected to the server via the Internet. In addition, the server stores a plurality of existent files each of which corresponds to an existent signature file.

Furthermore, when the first terminal wants to transfer a target file to the server, the first terminal generates a target signature file according to the target file and transfers the target signature file to the server. The server compares the existent signature files and the target signature file to determine whether one of the existent signature files is in accordance with the target signature file. If one of the existent signature files is in accordance with the target signature file, the first terminal cannot transmit the target file to the server.

The invention also discloses a network transmission method applied in the above network transmission system to solve the problems in the conventional technology.

According to an embodiment, the network transmission system includes a server and a first terminal, and the first terminal utilizes a first route to be connected to the server via the Internet. The network transmission method includes the following steps.

First, a plurality of existent files is stored in the server, and each of the existent files corresponds to an existent signature file. Afterward, when the first terminal wants to transmit a target file to the server, the first terminal generates a target signature file corresponding to the target file first and transmits the target signature file to the server.

Afterward, the server compares the existent signature files with the target signature file to determine whether one of the existent signature files is in accordance with the target signature file. If one of the existent signature files is in accordance with the target signature file, the first terminal cannot transmit the target file to the server.

These and other features, aspects and advantages of the present invention will become better understood with regard to the following description, appended claims, and accompanying drawings.

### BRIEF DESCRIPTION OF THE DRAWINGS

FIG. 1A is a schematic diagram showing a network transmission system according to an embodiment of the invention;

FIG. 1B is flow chart showing a network transmission method according to an embodiment of the invention;

FIG. 2A is a schematic diagram showing a network transmission system according to an embodiment of the invention;

FIG. 2B is a flow chart showing a network transmission method according to an embodiment of the invention; and

FIG. 3 is a schematic diagram showing the network transmission system according to an embodiment of the invention.

### DETAILED DESCRIPTION OF THE EMBODIMENTS

The invention provides a network transmission system and method. Several embodiments of the invention are illustrated herein below.

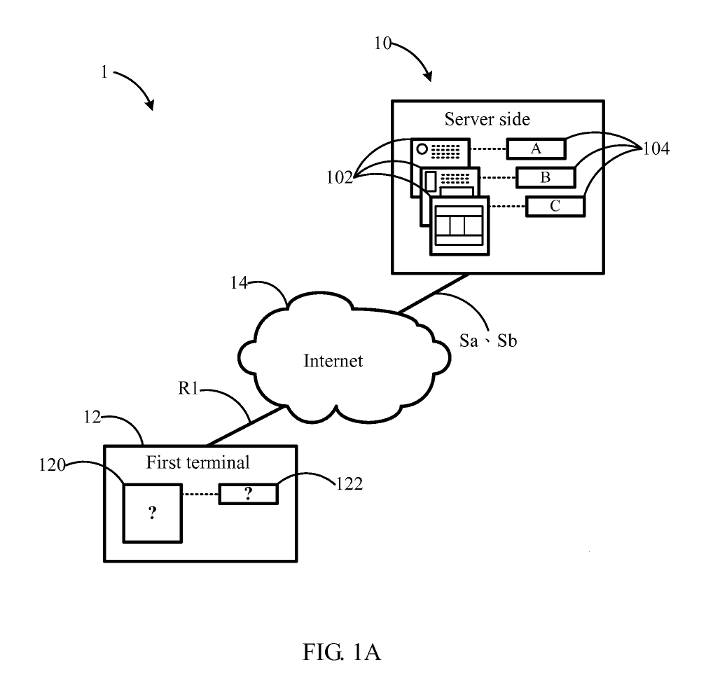

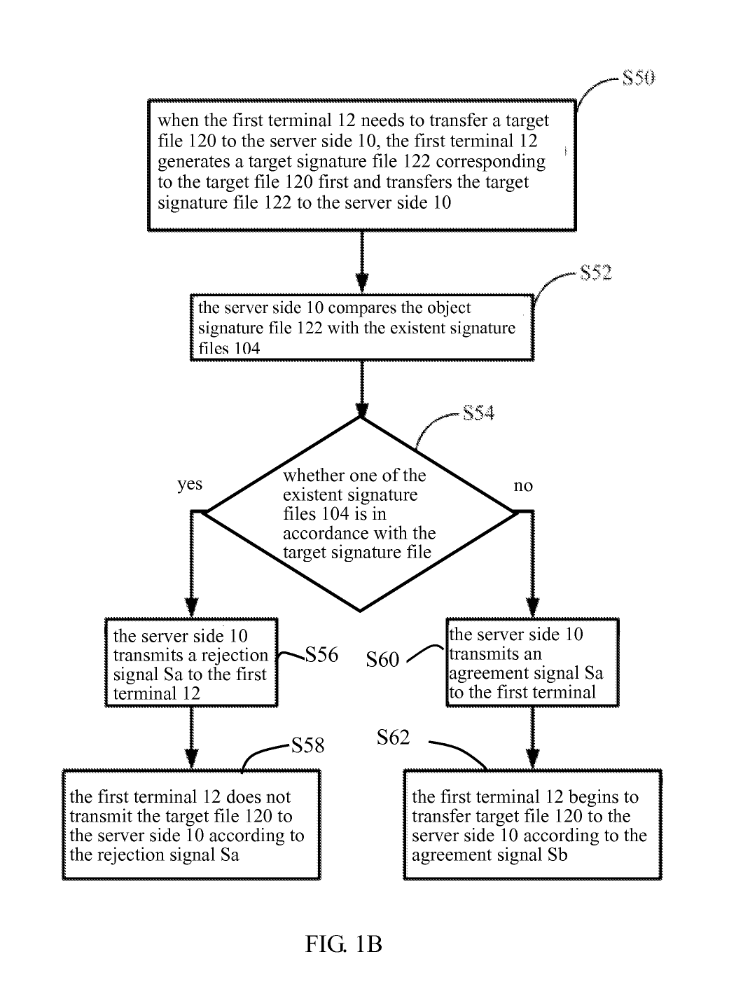

FIG. 1 A is a schematic diagram showing a network transmission system according to an embodiment of the invention. FIG. B is a flowchart showing a network transmission method according to an embodiment of the invention. The network transmission method in FIG. B may be applied to the network transmission system in FIG. A.

As shown in FIG. 1A, in the embodiment, the network transmission system 1 includes a server 10 and a first terminal 12. The server 10 stores a plurality of existent files 102 each of which corresponds to an existent signature file 104. In addition, the first terminal 12 utilizes the first route R1 to be connected to the server 10 via the Internet 14.

In practical use, the server 10 may be a server, and the first terminal 12 may be data processing equipment such as a desktop computer or a notebook computer, or even may be a mobile communication device such as a mobile phone or a personal digital assistant. In addition, the route R1 may be a physical line such as an asymmetric digital subscriber line (ADSL) or an optical fiber, and it also may a non-physical line such as wireless network connection.

As shown in FIG. B, the network transmission method of the embodiment includes the follow steps.

In step S50, when the first terminal 12 needs to transfer a target file 120 to the server 10, the first terminal 12 generates a target signature file 122 corresponding to the target file 120 first and transfers the target signature file 122 to the server 10.

In the embodiment, the target signature file 122 is preferred to be the checksum (such as MD5 checksum or SHA1 checksum, but the invention is not limited thereto) of the target file 120 with the length of the target file 120. Thus, as long as the substantial content of the file is the same, even if the file name is different, the server 10 of the invention may recognize it without being affected by the modified file name. In practical use, the target file 120 also may include other information relating to the target file 120 according to practical situation.

In step S52, the server 10 compares the target signature file 122 with the existent signature files 104.

In step S54, the server 10 determines that whether one of the existent signature files 104 is in accordance with the target signature file 22.

In step S56, if the determining result is yes, the server 10 transmits a rejection signal Sa to the first terminal 12.

In step S58, the first terminal 12 does not transmit the target file 120 to the server 10 according to the rejection signal Sa. In other words, when one of the existent signature files 104 is in accordance with the target signature file 122, the first terminal 12 cannot transmit the target file 120 to the server 10. In practical use, when one of the existent signature files 104 is in accordance with the target signature file 122, the server 10 may make the first terminal 12 unable to transfer the target file 120 via other mechanisms.

In practical use, the first terminal 12 is equipped with a display for displaying an interface relating to the server 10, and the first terminal 12 displays the file name of the existent file in accordance with the target signature file in the interface to inform that the target file 120 exists in the server 10 or inform if the transfer of the target file 120 has been finished.

In step S60, when the determining result in step S54 is no (namely, no existent signature file 104 is in accordance with the target signature file 122), the server 10 transmits an allowance signal Sb to the first terminal 12.

In step S62, the first terminal 12 begins to transfer target file 120 to the server 10 according to the allowance signal Sb. In practical use, the first terminal 12 transmits the target file 120 to the server 10 according to the file transfer protocol (FIP), the hypertext transport protocol (HTTP) or other proper transmission protocol.

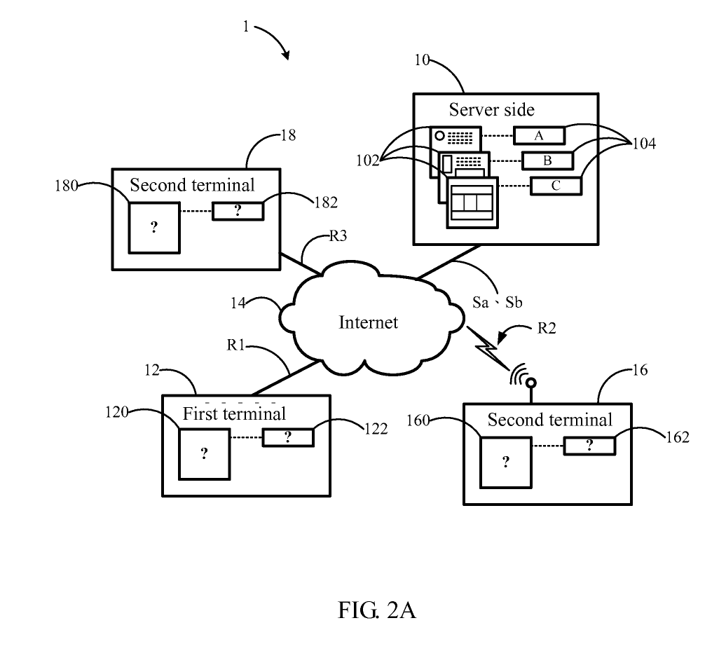

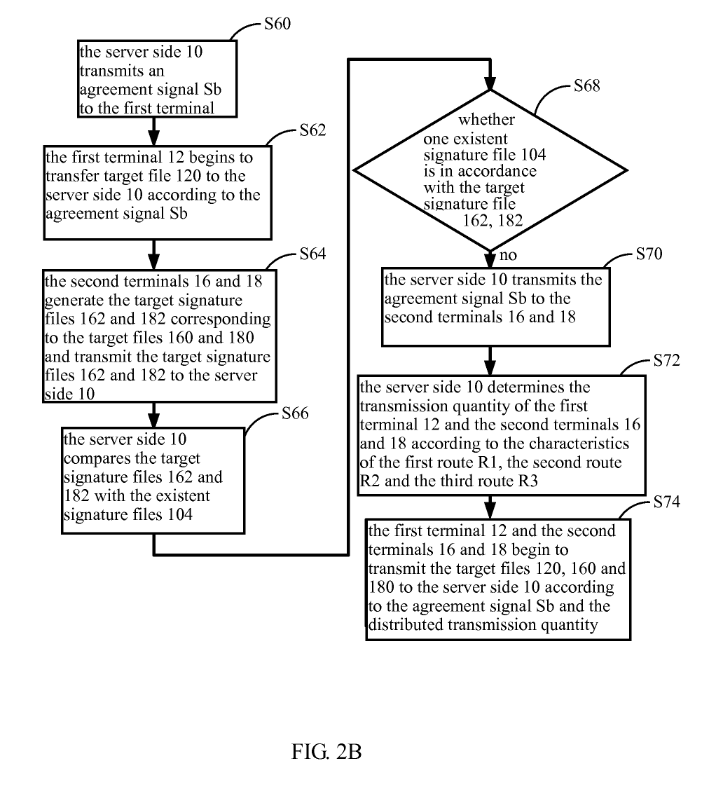

FIG. 2A is a schematic diagram showing a network transmission system according to another embodiment of the invention. FIG. 2 is a flowchart of a network transmission method according to another embodiment of the invention. The network transmission method in FIG. 2B follows the network transmission method in FIG. 1B.

In the former embodiment, when no existent signature file 104 in the server 10 is in accordance with the target signature file 122, the server 10 transmits an allowance signal Sb to the first terminal 12, and then the first terminal 12 transmits the target file 120 to the server 10 according to the allowance signal Sb.

As shown in FIG. 2A, the network transmission system 1 in the embodiment may include two second terminals 16 and 18. The second terminal 16 utilizes a second route R2 to be connected to the server 10 via the Internet, and the second terminal 18 utilizes the second route R3 to be connected to the server 10 via the Internet 14. The target files 160 and 180 and the target signature files 162 and 182 which are the same with the target file and the target signature file stored in the first terminal 12 are stored in the second terminals 16 and 18, respectively. In practical use, the network transmission system in the embodiment may include one or more than one second terminals, and the number of the second terminals is not limited to two.

As shown in FIG. 2B, the network transmission method in the embodiment may includes the following steps.

In step S64, the second terminals 16 and 18 generate the target signature files 162 and 182 corresponding to the target files 160 and 180, respectively and transmit the target signature files 162 and 182 to the server 10.

In step S66, the server 10 compares the target signature files 162 and 182 with the existent signature files 104.

In step S68, the server 10 determines whether one of the existent signature files 104 is in accordance with the target signature files 162 and 182.

In step S70, when the determining result in step S68 is no (that is, no existent signature file 104 is in accordance with the target signature files 162 and 182), the server 10 transmits the allowance signal Sb to the second terminals 16 and 18.

In step S72, the server 10 determines the transmission quantity of the first terminal 12 and the second terminals 16 and 18 according to the characteristics of the first route R1, the second route R2 and the third route R3 (such as the transmission speed, line stability, line location or other characteristics).

For example, in the embodiment shown in FIG. 2A, the first route R1 and the third route R3 are connected to the Internet 14 via physical lines, and the second route R2 is connected to the Internet 14 wirelessly, and therefore, the transmission speeds of the first route R1 and the third route R3 are usually faster than the transmission speed of the second route R2. Supposing that the ratio of the transmission speed of the first route R1, the transmission speed of the second route R2 and the transmission speed of the third route R3 is 3:2:5, the server 10 may determine that ratio of the transmission quantity of the first terminal 12, the transmission quantity of the second terminal 16 and the transmission quantity of the second terminal 18 also is 3:2:5.

In addition, the server may determine the file portions transmitted by the terminals 12, 16 and 18. For example, the server 10 may determine that the first terminal 12 transmits the front thirty percent of the target file 120, the second terminal 16 transmits the end twenty percent of the target file 160, and the second terminal 18 transmits the other fifty percent of the target file 180. These portions may be sequential or non-sequential.

In step S74, the first terminal 12 and the second terminals 16 and 18 begin to transmit the target files 120, 160 and 180 to the server 10 according to the allowance signal Sb and the distributed transmission quantity.

Following the above, the first terminal 12 transmits the front thirty percent of the target file 120, the second terminal 16 transmits end twenty percent of the target file 160, and the second terminal 18 transmits the other fifty percent of the target file 180 to the server 10, and these portions are recombined to be a complete file by the server 10.

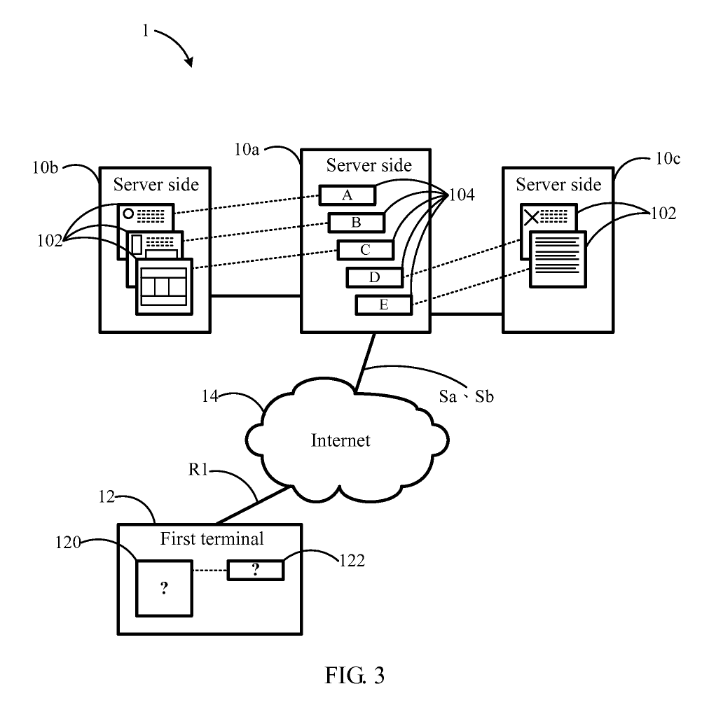

In practical use, the network transmission system in the invention may include a plurality of servers. FIG. 3 is a schematic diagram showing the network transmission system according to still another embodiment of the invention. In the embodiment, the network transmission system 1 includes three servers 10a, 10b and 10c which may not be placed in the same space and are connected with each other via the network. The servers 10b and 10c may be the storage servers for storing the existent files, and the server 10a may be a management server for collectively storing the existent signature files of the existent files. The first terminal 12 utilizes the first route R1 to be connected to the server 10a via the Internet 14 and communicates with the server 10a about the target signature file 122. If the first terminal 12 needs to upload the target file 120, it transfers the target file 120 to the server 10a, and then the server 10a selects one of the servers 10b and 10c to store the target file 120.

In addition, in practical use, the server of the network transmission system of the invention further stores a contrast table which may store the existent files and the existent signature file corresponding to the existent files, respectively. Thus, the server of the network transmission system may inquire the contrast table according to the content of the target signature file to confirm that whether one of the existent signature files is in accordance with the target signature file.

Compared with the conventional technology, the network transmission system and method of the invention provides a more efficient file transmission mode. Thus, users are more willing to upload files, the network resources are more plentiful, and the unnecessary waste of the network resources is avoided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A network transmission system, comprising:
a server storing a plurality of existent files each of which corresponds to an existent signature file; and
a first terminal utilizing a first route to be connected to the server via the Internet;
wherein when the first terminal wants to transmit a target file to the server, the first terminal generates a target signature file corresponding to the target file first and transmits the target signature file to the server, and the server compares the existent signature files with the target signature file to determine whether one of the existent signature files is in accordance with the target signature file, and if one of the existent signature files is in accordance with the target signature file, the first terminal cannot transmit the target file to the server.

2. The network transmission system according to claim 1, wherein the server transmits a rejection signal to the first terminal, and the first terminal does not transmit the target file to the server according to the rejection signal.

3. The network transmission system according to claim 1, wherein when the number of the servers is more than one, the existent files are dispersedly stored in the servers, and the existent signature files are stored in one of the servers.

4. The network transmission system according to claim 1, wherein the server stores a contrast table storing the existent files and the existent signature files corresponding to the existent files, respectively.

5. The network transmission system according to claim 1, wherein the first route is an asymmetric digital subscriber line (ADSL), an optical fiber or a wireless network connection.

6. The network transmission system according to claim 1, wherein the target signature file comprises a checksum of the target file and a length of the target file.

7. The network transmission system according to claim 6, wherein the checksum is a MD5 checksum or a SHA1 checksum.

8. The network transmission system according to claim 1, wherein when none of the existent signature files is in accordance with the target signature file, the server transmits an allowance signal to the first terminal, and the first terminal begins to transmit the target file to the server according to the allowance signal.

9. The network transmission system according to claim 8, further comprising:
a second terminal utilizing a second route to be connected to the server via the Internet, wherein when the second terminal transmits the target file to the server at the same time, the server determines the transmission quantity of the first terminal and the second terminal according to the transmission speed of the first route and the second route.

10. The network transmission system according to claim 8, wherein the first terminal transmits the target file to the server according to the FTP or HTTP.

11. A network transmission method, applied in a network transmission system including a server and a first terminal, wherein the server stores a plurality of existent files each of which corresponds to an existent signature file, and the first terminal utilizes a first route to be connected to the server via the Internet, the network transmission method comprising the steps of:
(a) when the first terminal wants to transmit a target file to the server, generating a target signature file corresponding to the target file first and transmitting the target signature file to the server by the first terminal; and
(b) comparing the existent signature files with the target signature file to determine whether one of the existent signature files is in accordance with the target signature file by the server, and making the first terminal unable to transmit the target file to the server if one of the existent signature files is in accordance with the target signature file.

12. The network transmission method according to claim 11, wherein step (b) further comprises the steps of:
(b1) transmitting a rejection signal to the first terminal by the server, and making the first terminal not transmitting the target file to the server according to the rejection signal.

13. The network transmission method according to claim 11, wherein when the number of the servers is more than one, the existent files are dispersedly stored in the server, and the existent signature files are stored in one of the servers.

14. The network transmission method according to claim 11, wherein the server stores a contrast table storing the file names of the existent files and the existent signature files corresponding to the existent files.

15. The network transmission method according to claim 11, wherein the first route is an asymmetric digital subscriber line (ADSL), an optical fiber or a wireless network connection.

16. The network transmission method according to claim 11, wherein the target signature file comprises a checksum of the target file and a length of the target file.

17. The network transmission method according to claim 16, wherein the checksum is a MD5 checksum or a SHA1 checksum.

18. The network transmission method according to claim 11, further comprising the steps of:
(c) when none of the existent signature files is in accordance with the target signature file, transmitting an allowance signal to the first terminal by the server; and
(d) beginning to transmit the target file to the server according to the allowance signal by the first terminal.

19. The network transmission method according to claim 18, wherein the network transmission system further comprises a second terminal which utilizes a second route to be connected to the server via the Internet, the network transmission method further comprising the steps of:
(e) when the second terminal also transmits the target file to the server at the same time, determining the transmission quantity of the first terminal and the transmission quantity of the second terminal according to the transmission speed of the first route and the transmission speed of the second route by the server.

20. The network transmission method according to claim 18, wherein the first terminal transmits the target file to the server according to the FTP or HTTP.
